(19) United States
(12) Patent Application Publication
(10) Pub. No.: US 2009/0320459 A1
(43) Pub. Date: Dec. 31, 2009

(54) Hydro-actuated engine

(76) Inventor: Clarence Edward Frye, Blountville, TN (US)

Correspondence Address: Clarence E. Frye, 301 Moore Dr., Blountville, TN, 37617, US

(21) Appl. No.: 12/457,797

(22) Filed: Jun. 22, 2009

Related U.S. Application Data
(60) Provisional application No. 61/213,247, filed on May 20, 2009.
(60) Provisional application No. 61/195,401, filed on Oct. 7, 2008.
(60) Provisional application No. 61/129,468, filed on Jun. 30, 2008.
(60) Provisional application No. 61/136,184, filed on Aug. 18, 2008.

(51) Int. Cl. F03B 13/00

(52) U.S. Cl. 60/398

(57) ABSTRACT

This water powered engine, when submerged deep in a moving body of water, functions as a four cycle engine, with water as it prime mover. It is a linear motor, just as if it were powered by ordinary fossil-based fuels. This invention harnesses the force of moving water and the pressure of water at a depth and creating a prime mover to power electrical generators or to do other work. When water is confined in a solid body and its force is applied to the surface of a piston, that force is transmitted equally, in all directions throughout the fluid or gas in the form of pressure. This characteristic is known as “Pascal's Law”. The component parts of this linear motor are a hydraulic cylinder, positive displacement pumps, a Venturi/Eductor vacuum assembly, an electronic piston positioning sensors, solenoid controlled valves and process program software. It is positioned to face an oncoming downstream water force. It may be either singular or in plurality as an array, this being a site adaptation design issue. Its purpose is to transform the limitless energy from moving water. It is an integration of existing technology of various fields. It is applicable to any comparable moving fluid source, particularly water. The coastal Gulf Stream and other ocean currents provide ideal environments as infinite sources of renewable energy.

### CROSS REFERENCE TO RELATED APPLICATIONS

This application claims all the benefit of the following U.S. Provisional Application Nos.

| | | |
|---|---|---|
| No. 61/213,247 | 20 May 2009 | HYDROSTATIC ENGINE |
| No. 61/195,401 | 07 Oct. 2008 | HYDROSTATIC ENGINE |
| No. 61/129,468 | 30 Jun. 2008 | HYDROSTATIC ENGINE |
| No. 61/136,184 | 18 Aug. 2008 | HYDROSTATIC ENGINE |

### FEDERALLY SPONSORED RESEARCH RELATED APPLICATIONS

Not Applicable

### FOREIGN APPLICATION PRIORITY DATA

### BACKGROUND—FIELD

This application relates to a linear motor submerged deep in a moving body of water, using natural motive forces of nature to produce hydropower, which could be used in the generation of electrical energy, utilizing the technologies of hydraulics and the Venturi Principle.

### PRIOR ART REFERENCES

Applicant is aware of the following U.S. Patents and Patent Application pertaining to water powered devices and the like. None of the citations, however, discloses a power system having the functional features or the capabilities of the present invention.

PATENTS

| | | |
|---|---|---|
| 4,465,941 | August 1982 | Wilson |
| 6,729,857 | December 2002 | Zatcioglu |
| 7,521,816 B2 | April 2009 | Helfrich |
| 984266 | February 1911 | Doney |
| 3,922,012 | November 1975 | Herz |
| 3,924,827 | December 1975 | Lois |
| 3,978,345 | August 1976 | Bailey |
| 3,980,894 | September 1976 | Vary et al. |
| 4,053,253 | October 1977 | Coffer |
| 4,053,787 | October 1977 | Diggs |
| 4,170,738 | October 1979 | Smith |
| 4,184,805 | January 1980 | Arnold |
| 4,347,036 | August 1982 | Arnold |

PATENT APPLICATIONS

| | | |
|---|---|---|
| 20080014100 | June 2007 | Lyons |
| 0,084,333 | April 2005 | Alberti |

FOREIGN PATENT APPLICATIONS

| | | |
|---|---|---|
| UA69558 (A) | September 2004 | Grygorov |
| 2,930,531 | February 1980 | Sandgaengder |

### SCHOLARLY REFERENCES

Handbook Of Natural Philosophy: Hydrostatics, Pneumatics. And Heat, by Dionysius Lardner, London Press (1855);

A History of Technology, Volume 5, Edited by Charles Singer, E. J. Holmyard, A. R. Hall & Trevor I. Williams, Oxford University Press, 1958;

### BACKGROUND—PRIOR ART

Various methods of generating power from oceans have been proposed or developed. The ones that are in a marine environment are OTEC, ebb & tide systems, wave energy. More specifically related to renewable energy sources & to the ocean environment, the following concepts & methods for generating power from oceans are current state of the art.

There are more than twenty one such patented systems on this general subject area, namely renewable energy generation from ocean waters. None of these have the same technical method as the Hydro Actuated Engine.

Ebb & tide systems are also subject to geographic constraints & require investments that are too costly. Neither could wave energy systems prove to be a globally applicable efficient energy generation system, as these mostly depend on wind directions.

OTEC systems have costly requirements; such as warm water flows of 7,450 kg/sec/Mw & overall great amounts of water displacement needs. Prior art systems also require cold water pipes with large diameters (57 feet per Mw) which all add to high costs.

The Hydro Actuated Engine is unlike any of these previously patented systems. All other attempts have failed to establish a basic hydraulic circuit in a totally submerged underwater environment. Rather than review each of the above referenced Patents or Pending Patent Applications, a generalized response can be made which clearly differentiates all of them from this Patent Application. It is our position that none of these referenced patents contain all of the elements listed below, which this Patent clearly does possess:
1. A body of water;
2. Many of these inventions do not use the classic hydraulic cylinder technology in combination with the positive displacement pump and/or a rotary hydraulic motor (“linear motor”); Many of these inventions do not use electronic systems for remote control purposes in a depth of a moving body of water;
3. None of these other inventions can employ the water in multiple ways, as the prime mover;
4. None of these other inventions combine the applications of hydraulics, hydrostatics, hydrokinetics, the Venturi Principle/Eductor and electronic control technologies;
5. Finally, none of these other inventions can open a “hole” or lowered pressure zone in the ambient water environment and keep it open, to ensure the continuous reciprocation of engine cycles, essential to making full use of raw water energy i.e. mechanical energy for generation of electrical energy.

In fact, the only common feature that all of these referenced devices possess with the invention which is the subject of this Patent Application is the use of the power of water. This invention is the perfect hydraulic circuit. This is a four cycle engine which performs all functions simultaneously at each single stroke and makes the fullest use of the kinetic energy of water to generate electrical power. This device is unique and could possibly require a new designation in the patent classification system or new sub-class within section 290.

### SUMMARY AND BACKGROUND OF INVENTION

This invention generally relates to the use of hydraulic, Venturi Principle and electronic control technologies to capture and provide energy from moving bodies of water. It is understood that energy is the basis of civilization as we know it. In the present circumstances, our primary source is by fossil-based fuels, which are not environmentally friendly and are finite in quantity. The demand for energy is insatiable. Finding renewable, environmentally friendly sources of energy is a matter of national security.

This invention, a water powered engine, captures and transforms the energy of flowing water. It uses existing technologies, natural forces of wind and gravity, and the unique molecular properties of water. They are understood as Pascal's law and consequential effects of the Venturi Principle. When they and the technologies are properly employed, they enable a pressure differential to be established in a pool of renewable energy. The advantages offered by hydraulics are: they consume no matter, provide for force multiplication of pressure, and furnish hydropower for generating electricity or general purposes. This hydraulic power is portable, ready to generate electricity and is the ultimate form of energy.

Our Earth is a water planet. Within the oceans are moving masses of energy as ocean spanning currents with crushing pressure, due to depth. If mastered the benefits are incalculable. In the Straits of Florida, the Gulf Stream, a moving body of water within the Atlantic Ocean, reaches depths of 2,000 feet and moves at the rate of about 5 miles per hour. Also impounded bodies of water, held by hydroelectric dams are a vast source of energy. These renewable energy sources, powerful beyond belief, will be with us long as the Earth exists.

Hydropower is measured according to the amount of power released, or energy per unit time. Most hydropower comes from a mass, flow rate and/or pressure due to weight (head) effects of elevation changes. This invention, a linear motor, when placed within a body of infinite energy, serves as a leveraging fulcrum to develop mechanical energy to drive pumps to produce hydropower.

This invention relies on (1) the incompressibility of water and its mechanical properties, and (2) natural forces that assure the intake of water into the hydraulic cylinder and the motive force to support the vacuum effects of its Venturi exhaust system. Gravity and other natural forces of nature assure the intake of water into the input ports as hydrostatic pressure together with a continuous water flow as a motive force for the Venturi Principle exhausting system.

This system uses hydraulic technology with electronic process control to harness the natural properties of matter. It transforms molecular energy into mechanical energy. As in all hydraulic circuit functions, the use of non-compressible fluids necessitates low back pressure within the cylinder during the power stroke. The Venturi Principle application addresses back pressure by adequate exhaust function via eductor provided suction.

Water accepts pressure from any source and transmits it as hydraulic energy to any object offering resistance. As a solid it occupies a certain space, thus when encountering a fulcrum it is in the strictest sense a machine.

### Principles of Physics Utilized in this Embodiment

Molecular energy is a property of water as stated in Pascal's Law. Its molecules are constantly moving. They slip and slide past one another even when they at rest in their passive form. The movement of molecules in the water is molecular energy. The inexhaustible quantity of molecular energy in a body of water becomes the kinetic force which powers this enablement.

As in all hydraulic cylinder functions, the use of incompressible fluids, requires back pressure consideration. The Venturi Principle usage addresses both back pressure avoidance and the exhaust function.

Bernoulli's equation states that when water flows as a streamline through a pipe with a smoothly varying constriction, the flow will gain speed and pressure while passing through the constricted area (narrow space known as a Venturi tube). This creates a vacuum. A pipe inserted (known as an eductor) into the Venturi tube and connected to hydraulic cylinder ports will suck fluid (as water) up and mix it with water flowing thru the tube for discharge.

When placed at depth, gravity exerts pressure on every square inch of a solid's surface area of exposure. Therefore, external ambient pressure must be resolved in a submerged environment. The Venturi principle with an educator function is an integral part of the invention. Its application provides for the exhausting of water back into the ambient environment.

Mechanical energy is the link, which applies hydraulic energy from a linear motor to a workload and causes it to do useful work. The resisting work load could be a hydraulic pump, known as a rotary motor.

The air pressure exerted on the water surface via a conduit/port into the hydraulic cylinder acts as a venting agent for each stroke, within the back side of the two positive displacement pump barrels.

### Mathematical Proofs of Capability

The potential of this embodiment is subject to mathematical proof. For proper understanding of its scope, it is necessary to discuss the weight and pressure of water at a representative depth. It is ascertained that the weight of a cubic foot of water at the common temperature of 65 degrees F., is equal to 7.5 gallons at a weight of 62.4 pounds. Thus the pressure (psi) at the bottom of a column of water is equal to the height of the column in feet times 0.434 pounds. The power and versatility of the potential from the perspective of the head of water only (excluding all water flow motion forces) can be demonstrated by example.

Assume we have a hydrostatic engine at a depth of 300 feet with a 30-inch diameter piston in the middle sectional chamber and pistons within the end section pumps. At a depth of 300 feet, there would be 11,047 gallons of water above the hydrostatic engine. The water pressure at the level would be approximately 130 psi of the 30 inch piston surface.

A 130 psi force acting on a 30-inch diameter piston area (707 square inches times the psi of 130), can move a 91,910 pound load the length of each piston stroke. Also the 12 inch diameter piston (113 square inches times 130 psi) can move a 14,670 pound load. The three pistons being connected by a single hydraulic cylinder rod must move together with each stroke motion. The total energy of 106,580 pounds is thus transformed as mechanical energy to the one pump piston at the end of power force stroke.

The force delivery-end pump piston is subject to a force multiplication factor of 7.256 times the 130 psi. If we multiply the water pressure at 300 feet of 130 psi times the surface area of the piston of 113 square inches, then by the multiplication factor of 7.256, we arrive at the pounds of hydraulic force of 943 psi. This force of 943 psi times the area of 113 inches gives us the total output of 106,559 total pounds of force for the stroke travel distance of the piston.

The output of the hydrostatic engine in this example can be manipulated by adding multiple cylinders, using larger cylinders, and/or operating at a greater depth of water. For example, in the 1850's in England, a water company operated a steam driven, hydraulic cylinder with an 11 foot stroke, a 100 inch diameter cylinder, with an 880 horsepower steam engine to lift 5 million gallons of water a day.

### Site Location for Invention

This water powered engine uses as its prime mover, a moving water mass such as an ocean current, the gravity intake of a hydroelectric dam penstock, or a fluid pressure equivalent. Its purpose is to harness the potential energy present in fluids as a renewable alternative energy source. We believe this invention is the first hydraulic four-cycle engine with a reciprocating power stroke that can be powered by and harness the energy of water, when totally submerged in a pressurized water environment.

Water and its fulcrum is in fact a Machine. All it requires is a water flow force with a means of passing it thru a hydraulic system and exhausting it outside of the cylinder

The best source of water force is ocean currents, such as the Gulf Stream and other ocean currents, due to massive water flows. Lesser sources are rivers, pipelines, and hydroelectric dams with water flowing for release into penstocks. The movement of water and depth found in ocean currents is self evident, as is its powerful force.

Water is a lever which acts with force upon a fulcrum, i.e., the hydraulic cylinder, to transform hydro power into mechanical energy. The positive displacement pumps portion of the hydraulic cylinder convert the mechanical energy back into hydraulic energy.

### DRAWINGS—BACKGROUND

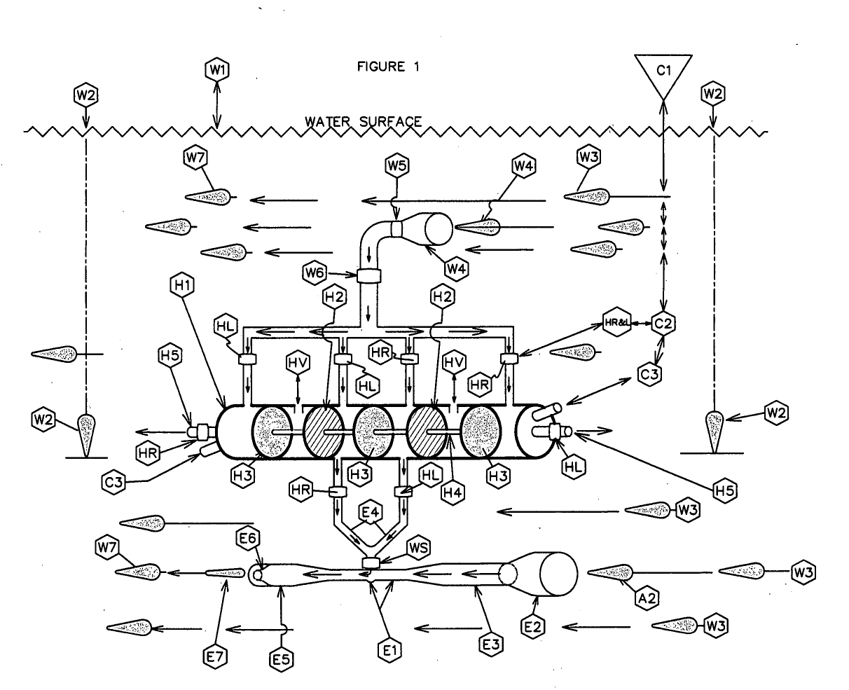

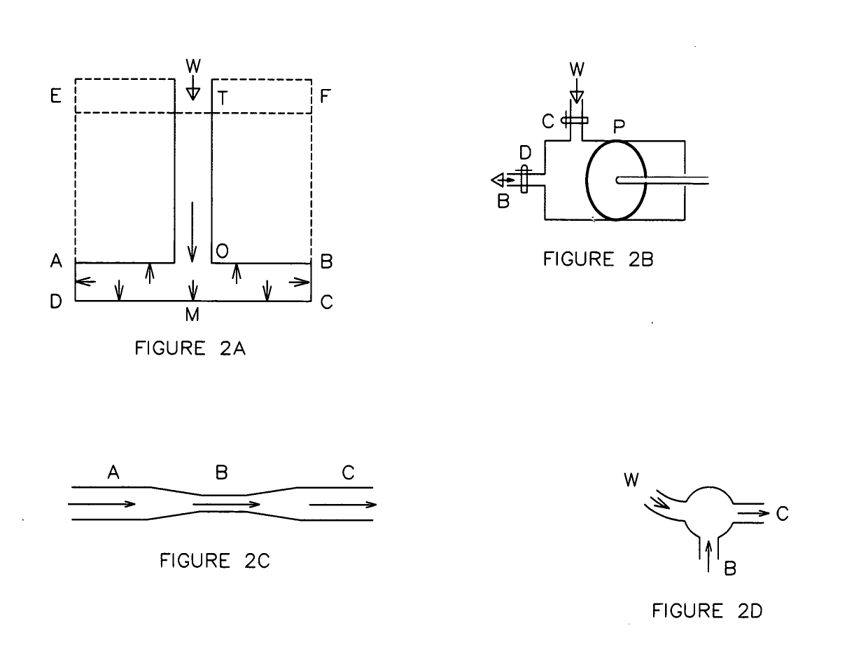

The system has its hydraulic parts under water. The system is stabilized by appropriate structural support members. The support system is a function of dimensions and pressure/volume capabilities for any application. The specifications layout must include all components shown in FIG. 1, with the faithful observance of all narrative text, which describes all aspects of this enablement and embodiment. The FIG. 2 drawing, items A through D are concepts embodied in the enablement and are self evident in its makeup.

The computer management control system must include sequencing programs and instrumentation sufficient to operate and maintain the system, with full consideration and inclusion afforded the requirements of specific end item applications. In brief, the system must be able to sense system conditions and sequence pressure flows thru the operating system of valves. For controlling the stroke reversal event, sensors are placed in the positive displacement ends to determine when the piston is fully extended to its terminal position, after which the reversal stroke begins. This is the heart of a reciprocating engine.

The system, being robust and expandable, can easily be designed and fielded as standardized system packages, ranging from miniaturized power versions to either standardized or unique industrial sized versions.

### DRAWINGS—FIGURES

FIG. 1

W1. Atmosphere lying above the surface of the water mass in which the enablement is submerged;

W2. Directional indicator of hydrostatic water pressure head which would overlie the enablement, when submerged in a body of water;

W3. The upstream flowing water current which surrounds and powers the enablement, its hydraulic component and the Venturi/Eductor assembly;

W4. Shrouded entrance and entry port of the moving high pressure water flow use as the motive power source;

W5. In line filter to screen out impurities and keep out debris from fouling the valves and ports of the hydraulic cylinder;

W6. Master on/off switch which denies or permits the pressurized water force access to the interior of the hydraulic cylinder. Its counter-part is the master switch (WS) which has a similar on demand function for the suction side of the engine exhaust component;

W7. The downstream water flow which has passed the enablement by and is moving the water discharged from the jet nozzle exit point (E6) away with it;

WS. Master on/off switch for the suction function which drains the cylinder chamber and discharges it into the venturi assembly (E1). Its counter-part is the master switch (W6) which denies or permits access to the interior of the hydraulic cylinder;

C1. Electronic control process director to open & close solenoid controlled valves (HR & HL) regulating entry/exit ports for the hydraulic cylinder and the Venturi Principle exhausting system for activating eductor functions;

C2. Electrical harness for linking piston positioning sensors to the process control director for relay/signal to solenoid controlled valves to open/close ports whenever a piston has reached the terminal point of its stroke. The signal to the respective valve combination reverses the stoke action for repetition following a recurring reciprocating pattern. This is analogous to the four cycle engine pattern but it is achieved herein by hydraulics & the Venturi in a single stroke move by means of electronic timing control sequences;

C3. Piston position sensors which signal when a probe is in the magnetic field due to the piston being in proximity to the sensor. The sensor signals the process control to open/close the combination of valves, thus reversing the direction by permitting the water mass force to engage different piston surface areas;

HR. Solenoid controlled switching valves to permit or deny entry of water mass into the hydraulic cylinder;

HL. Solenoid controlled switching valves to permit or deny entry of water mass into the hydraulic cylinder;

H1. Hydraulic cylinder walls with water entry/exit ports;

H2. Hydraulic cylinder sectional walls to provide three working chambers;

H3. Hydraulic cylinder pistons which move back and forth within each sectional chamber resulting in increasing, decreasing chamber volumes;

H4. Hydraulic cylinder piston connecting rod;

H5. Pump exit point and hydraulic energy stream produced by the enablement. By way of a conduit it feeds (not shown as self evident technology for energy usage) an Energy Cell (accumulator) and then as a flow to drive a Rotary Hydraulic Motor which then applies torque to drive an electrical generator. This is a circuit which transforms raw water energy into electrical energy, a near perfect form of energy;

HV. The venting ports, which have a conduit extending to the atmosphere above the water surface, they are open and prevent a vacuum from arising in the back side of the pump chambers, as the piston expels the water during each power stroke. An optional use, although not shown, would be to compress air and store it in an energy cell. This optional feature would be self evident to anyone skilled in the art of hydraulic/pneumatics;

E1. The Venturi principle back pressure exhaust system for preventing back pressure build up in the chamber of the middle section of the hydraulic cylinder;

E2. The shrouded entrance port for entry of the water mass into the Venturi back pressure exhaust system;

E3. The smooth pipe first section of the Venturi exhaust system;

E4. Solenoid switched valves which open/close to permit water to drain from chambers in the middle section of the hydraulic cylinder to prevent back pressure build up;

E5. The smooth pipe final section of the Venturi exhaust system;

E6. The exits section of the Venturi exhaust system terminating with a jet nozzle for ejecting the water mass back into ambient the flowing water mass environment;

E7. The area near the mouth of the jet nozzle experiencing a vortex/turbulence space with a lowered pressure differential. The turbulence is caused by the water mass flowing along the external surface of the jet nozzle, which is a form of resistance impeding its path of flow. This event, in the continuous flowing water mass, facilitates the reentering of motive and entrained drainage water exiting the Venturi exhaust system.

FIG. 2A

The hydrostatic paradox is the power of water to be pressurized;

Let A B C D be a closed vessel, with a small hole O on the top, in which a narrow tube T is screwed, water tight. Let the vessel A B C D be filled with water W. The pressure on the bottom C D will be equal to the weight of a column of water whose base would be equal to the area of the bottom C D, and whose height would be T M; that is, it would be equal to the quantity of water W, which would fill a vessel whose base is C D, having perpendicular sides D E and C F, and whose height is D E;

However shallow the vessel A B C D, and however narrow the tube T O, an indefinitely small quantity of water may be made to produce a pressure on the bottom of the vessel which it contains, equal to the weight of any quantity of water, however great. The pressure depends only on the depth of D C below the level of the water in the tube T O.

FIG. 2B

When an exhausting syringe is inserted into a body of water, as is in the enablement shown in FIG. 1 (W3, W2 & W4), it intakes water as its chamber volume increases and expels the water under a compressing force as its chamber volume decreases;

The double rod, double acting cylinder (i.e. reversing or reciprocating mode), in FIG. 1 (H1) used by the enablement with positive displacement pumps attached to the two rod ends is literally a syringe. The mechanical cylinder rod increases and decreases chamber volumes for in taking (HR & HL) and expelling (H5) water within its submerged water environment;

A cylinder P having a solid piston moving air tight in it. Let C be a tube proceeding from its upper side, furnished with a stopcock C and let B be another tube furnished with stopcock D. Let tube C be inserted into a body of water W under ambient pressure. If the piston then be raised in cylinder, the cock C being open, the water W will under ambient pressure will rise so as to fill the enlarged space provided by raising the piston. When the piston is brought to the top of the cylinder, let cock C be closed and cock D be opened. By lowering the piston the water W will be expelled as the space is decreased.

FIG. 2C

The Venturi tube is based on the long known theorem of Bernoulli, in that a liquid flowing from left to right between A and B that the velocity increases and the pressure correspondingly decreases. There is a simple relationship which exists, as volume falls the velocity increases and that as it moves from B to C the volume increases and the velocity decreases. The velocity at point B can produce a vacuum which is the basis for the eductor suction function of FIG. 2D. When the two, 2C and 2D are put into a working relationship, such as exists in FIG. 1, the enablement, they can drain the spent water from the chamber of H1, the reciprocating hydraulic cylinder. This avoidance of back pressure build up enables the power stroke to occur and thus to apply the water force W4 as mechanical energy via the piston cylinder rod to the positive displacement pumps, i.e. to create a void or hole in front of the advancing piston during the power stroke.

FIG. 2D

Pumps employing the jet-pump principle, long known, are as follows, the jet drags the surrounding liquid along with it causing a reduction of pressure beyond the nozzle and in the suction pipe sufficient to raise water from a sump or source. This principle in practical form was reported based on experiments in 1853. The jet-pump observes these basic principles of fluid dynamics. A stream of water (or fluid) is its prime mover as is in this enablement, FIG. 1 (W3 & A2), it flows thru a conduit or pipe shaped in the form of a Venturi. The water (fluid) accelerates as kinetic energy velocity, streaming past E2, E3, & E5, entraining a second water stream sucked from E4 conduits which in turn have as a stream source the water arising from a decreasing volume in one chamber of the hydraulic cylinder arising from an advancing power stroke, avoiding back pressure by creating a void (hole) in front of the advancing piston H3. This secondary stream is mixed with the primary (motive) stream and then through E5 and discharged at E6 as a jet stream into E7 formed by the discharge, then by external surface flow by of W3 alongside the exhaust point E6 then joined with W7 as downstream current;

The discharge thru E5 has lost part of its energy due to encountering the secondary stream at E1 which it includes as a combined stream. But it must be known that the pressure at the exit point E6 is largely determined by the ratio (volume) of the two streams. Since the primary stream W3 is not constrained in terms of force, being vast, it can have a favorable ratio in respect to the volume of the secondary stream from E4. This ratio advantage is not the ordinary case for fossil-fuel based prime movers which have economy/efficiency constraints;

Jet pump. The jet reduces the pressure behind the nozzle C and causes water to rise in the suction pipe B then the water supply, motive force moves through the delivery pipe D. The motive force A2, which as a prime mover powers the suction force is shown as FIG. 1A. This kinetic force A2 flows continuously into and through the pipe and nozzle. The jet-pump is known as a Venturi Eductor.

### DETAILED DESCRIPTION OF INVENTION—FIRST EMBODIMENT

### Overview of Invention

This invention is in all respects a linear hydraulic motor which can perform all four-cycle engine functions simultaneously. The preferred embodiment, when placed and operated at a depth, within a body of water, is in fact, an infinite molecular power source.

To begin, the Hydrostatic Engine is positioned in a body of flowing water mass, at a depth and positioned by attachment or tether. The system's shrouded intake ports must be oriented so as to be directly facing the oncoming stream of flowing water. The exit of discharge point faces downstream.

The water flow passes thru the shrouded input port and flows through the inline replaceable filter and fills the conduit until it applies its restrained force against the four (4) closed solenoid switched valves which control entry into the ports of the three (3) hydraulic cylinder chambers. Two (2) ports open into opposite ends of the center section chamber, which is the power stroke chamber.

The cylinder contains a piston within the main section of the hydraulic cylinder with positive displacement forcing pumps in sections on each end. The surface areas of the pistons in each pump chamber determine the flow and gallons per minute of highly pressurized water expelled out of the system for end user applications.

A port, being on each end of the middle chamber, permits the reversing of the power stroke depending on which valve is open with the other being closed. The force of the water mass then bears on the respective piston surface and moves it toward the end of its chamber's sectional wall, at the same time the moving piston, being attached to single cylinder connecting rod, causes the other two (2) pistons to move in opposite directions within their respective sectional chambers.

The reciprocating action of the double acting hydraulic cylinder is made possible by a piston, which divides the middle chamber section of the cylinder into two halves. There are three sections; two on the cylinder ends, which serve as hydraulic water pumps. As the water force enters the middle chamber section and presses on and moves the dividing piston forward in the cylinder, one side of the chamber increases in volume as the other opposing side decreases. The water in the decreasing chamber side, in response to this stroke, must be drained out to prevent back pressure resistance.

This invention uses the Venturi Principle method to avoid back pressure from occurring in the reducing volume chamber of the hydraulic cylinder, during the power stroke.

This is how the Eductor pipe drains the decreasing volume chamber in front of a power stroke (increasing volume chamber) and prevents back pressure buildup. The pipe beyond the constricted area is normal size, so the flow returns to about it original speed and pressure before exiting the pipe. The embodiment has a continuous stream of water running through it at all times.

The water flow passes thru the Venturi pipe exhausting system with a partial vacuum present in the educator pipe as it passes the Venturi constriction and out thru the jet nozzle. At the same time a flow is also moving along the outer (external) surfaces of the total system. The ambient area in the vicinity of the Venturi jet nozzle exit point is in a vortex state with a lower pressure differential in the immediate front of the jet nozzle. The stream of water from the exhausting system exits and blends with the ambient flowing water stream pump chambers.

Downstream as the pipe regains its normal size, the pressure drops to about the same pressure level at which it first entered the pipe. The pipe when fitted with a tapered nozzle produces a jet stream with downstream capitation which effects immediately in front of the jet discharge point. This facilitates the reentry of the drainage water into the ambient water mass flowing by the discharge vicinity.

The Venturi/Eductor assembly, as the engine's integral exhausting system, is equivalent to the suction side of the typical fossil fuel powered prime mover found in millions of ordinary hydraulic circuits, which are typical linear motors. Drainage water is discharged thru a jet nozzle in the exit portion of the Venturi exhaust pipe into the outside body of water flowing past outside the discharge point. The jet stream produces a turbulence area, or vortex area of cavitations.

The electronic process control director is connected above the water surface to an external power supply and is energized. The solenoid switching valves are either in a closed or opened position for all entry/exit ports. There are eight (8) valves, four (4) which move the pistons from right to left as a stroke. When the other four (4) are opened the stroke is reversed and the travel is left to right as a stroke. This movement pattern is the heart of the reciprocating engine. This water powered engine does all four acts (functions) of a fossil-based four cycle engine: intake, compress, power, & exhaust. Only it does so at great volume without consuming any matter in a total friendly way to the planet. This has never before been accomplished before using hydraulics in this manner.

This invention is practical and operates in an environmentally friendly way of delivering hydraulic energy. In the preferred embodiment it can provide a hydraulic force at any desired intensity level and volume. The intensity level and volume of output is determined by the ratio of the pistons cross sectional areas differences. Also the total flow rate of the output is simply a matter of attaching additional positive displacement pumps, as integral parts of a total system.

The system uses a Venturi/Eductor exhausting system. The process is managed by electronic sensors and solenoid switched valves to open/close the entry/exit ports. The pistons move back and forth in their chambers with the sensors signaling the cadence.

This invention is practical and operates in an environmentally friendly way of delivering hydraulic energy. In the preferred embodiment it can provide a hydraulic force at any desired intensity level and volume. The intensity level and volume of output is determined by the ratio of the pistons cross sectional areas differences. The system is portable and can be greatly expanded for increased volumes and pressure levels. The system can perform the work output of conventional fossil fuel powered prime movers. The difference is its prime mover is natural forces and its operation is completely environmental friendly.

The system is portable and can be greatly expanded for increased volumes and pressure levels for the generation of electricity or other uses. The prime mover is powered by natural, environmental friendly forces. The system can perform the work output of conventional fossil-fuel powered prime movers without the consumption of any fuel or any non-renewable resource.

### Component Description

All references made herein are to items as identified on the FIG. 1 drawing.

This Invention is a four cycle engine powered by the natural forces (W2 & W3) of the earth, an infinite source of renewable energy. It does not consume matter. It transforms energy states.

In the preferred embodiment, the engine is immersed in an overlying body of water. The (W2) hydrostatic head is further increased as a force by the velocity of the upstream (W3) moving current entering the shrouded entry port (W4). The pistons within the two chambers, react to this force as a functioning unit i.e. transforming energy via a pump to any resistance external to the engine itself. The force entering the shrouded port (W4), since liquids are not kinetic as is a gas, proceeds via the engine, leveraged by a fulcrum, then onward externally by a conduit to encounter or impress its force against an opposing resistance. It could be an energy cell (accumulator) or a hydraulic cylinder (rotary motor) which in turn spins an electrical generator to produce an electron flow.

The water force enters the system at a single (W4) shrouded port oriented to receive the pressurized head of water (W2) with the downstream velocity of the (W3) water force flow. A conduit routes the water force to four entry ports opening into the three chambered sections of the cylinder. The conduit has a (W5) filter and a (W6) master solenoid controlled valve which regulates further entry farther into the system. It functions as start/stop (opened or closed) control. It remains open at all times during the system's operating mode.

The four ports (HR & HL) for entry by (W4) water force are opened/closed by solenoid switched valves. Two ports are designated as (HR), and two as (HL). A valve can only be in an opened or closed state. Whichever pair of valves are opened determines the direction to be taken by the power stroke. By switching pairs of entry ports the system reciprocates back and forth.

The (H1) cylinder also has two (HV) ports that have a conduit that leads up to and above the (W1) water surface. There are vents to the back side of the pump chambers (C3) which prevent a vacuum from occurring during the expelling action by each pump. They also have an optional use. They could be used to capture and produce kinetic energy in the form of pressurized air by adding (not shown) control valves and an energy cell accumulator.

The hydraulic portion of this enablement is a (H1) double acting, double rod cylinder. The cylinder has two interior walls (H3), which create three separate chambers. This (H1) cylinder applies a (W2 & W3) water force to the three (H3) pistons, two being in positive displacement chambers on the ends of the cylinder.

The (H1) cylinder acts as a fulcrum with (W4) water pressure, as a long lever pushing two pistons, entry ports (HR or HL), to extend a single (H3) piston, within one of the two displacement pumps. The (H4) cylinder rod applies mechanical force to all (H3) pistons.

The hydraulic (H1) cylinder converts water pressure into mechanical energy by driving the (H3) piston in an expelling pump, either on the right or left end of the cylinder. The expelled hydraulic force leaves both ends of the cylinder via exit ports (H5), a conduit. Solenoid switched valves (HR & HL) open and close the pump exit as necessary for the proper operation. When expelling water, the valve is open and the valve on the other end is closed, it being in the force entry mode, i.e. as one pump expels while the other one intakes a water force (W4).

The water in a pump chamber, when urged forward by a piston (H3), applies hydraulic energy, (pounds per square inch), to any resisting object it encounters upon exiting the pump body at an exit port (H5). This hydropower could be used to direct drive a hydraulic pump, a rotary motor, or stored in an energy cell or an accumulator. A rotary motor, with an energy cell could act as an in between intermediary power if needed and could drive an electrical generator. These items are not shown because they are clearly understood and self evident to individuals skilled in the art of hydraulics.

In the preferred embodiment, this enablement will be the power source for an electrical generator, and if located below the water surface (W1) it will need to exhaust the spent water force from its companion rotary motor back into an ambient high pressure zone. The (E1) Venturi/Eductor system, an integral part of the enablement, would solve this problem. It would be connected to the discharge port of a rotary motor.

The cylinder pistons (H3) can multiply the hydraulic pressure (pounds per square inch) transferred by the power stroke. In this case, as the pressure is increased, the volume of water expelled is decreased.

Pressure and volume changes are achieved by using smaller (H3) pistons in the pump chambers and a larger (H3) piston in the middle chamber of the cylinder. The ratio of the smaller piston areas to the larger piston area is the force multiplier.

Since the pumps, placed at each end of the hydraulic cylinder, are connected by a single (H4) cylinder rod, it follows that the power stroke, while expelling water from one pump, is at the same time taking water in the port (HR or HL) of the opposite pump. This is a pressured water intake, as it also acts on the pump piston as a force. This increases the power factor because two pistons are always pushing a third piston in the power stroke.

When a pump piston is pulled backward by its connecting cylinder rod (H4), an increasing volume is formed within the pump chamber. The solenoid controlled valve, (HR or HL), opens an inlet port and pressurized water (W4) enters, filling all space. As the next reversing power stroke begins, a decreasing volume is formed within the same chamber and the water is expelled at its exit port (H5). The pumps acts as would a syringe when reciprocating, it would intake matter and expel its contents. When this occurs the engine has achieved its purpose, the product is useable hydraulic energy.

The critical spent water exhaust function, or cylinder chamber back pressure avoidance, is achieved by a drainage system using the Venturi Principle (E2,3,1,4 & 5) with the motive power force supplied by the flowing (W4) water mass, together with an Eductor assembly (E4) with control valves (HR & HL) The suction system being switched on and off by master control valve (WS).

Spent water removal is managed by solenoid controlled valves (HR & HL) in the Eductor conduits (E4). When one valve (HR or HL) is opened for chamber draining, the other is closed for the then occurring power stroke event.

Since water, being incompressible, occupies much of a cylinder's chamber following a power stroke, it must be removed partially, as another power stroke begins in the opposite direction. A Venturi Principle pipe (E1) and Eductor pipes (E4) are used to suction the water from the chamber and to discharge it outside the system where it merges with the passing water flow (W3, E7 & W7). Removal ahead of the reversing power stroke prevents back pressure resistance within the chamber as it is decreased in volume. This permits the opposite side of the chamber to accept the pressurized water by increasing its volume, thus applying its force to a piston surface area.

The Venturi assembly (E1) is a tube or pipe, with its entranment chamber, permits the (A2) water mass to flow thru it continuously as a motive power source. The motive power flow (A2) enters a shrouded entry port (E2). This creates suction in (E4) eductor conduits which are connected to the cylinder and the tube (E1) where the drainage from the cylinder chamber is mixed into the (A2) motive power stream of flowing water.

The area (E7) in front of the mouth of the jet nozzle experiences a vortex/turbulence space with a lowered pressure differential. The turbulence is caused by efflux from the jet nozzle (E6) and the water current (W3 & W7) flowing across the external surface of the Venturi pipe (E3 & E4) which is a form of resistance impeding its path of flow. This event, arising in the external flowing energy systems water mass facilitates the reentry of water exiting the exhaust system of this embodiment. This completes a hydraulic circuit, although unconventional in method by this enablement. The usual circuit has a holding tank from which its prime mover suctions the fluid for circuit recycling.

This enablement, comprising a reciprocating four cycle engine, is managed by an electronic controller director (C1) with its interrelated wiring network (C2) which handles signals from piston positioning sensors (C3) at stroke terminal points to activate solenoid controlled valves (groups HR or HL). These valves regulate the reciprocating functions of the total system.

A signal that a piston is at its terminal stroke point in either pump chamber will energize valve groups (HR or HL) to move to on/off positions, thus reversing the flow into or out of both groups. Each valve group contains two entry ports and two exit ports, the open or closed state for each group depends on which direction, right or left, the power stroke is to move.

Software programs and hardware, as in components (C1, C2 & C3) are readily available prior art from commercial suppliers to the hydraulic actuator trade who design and produce for specific applications.

The system has two master on and off control switches (WS & W6) responding to an electronic command to open/close the solenoid controlled valve. They deny or permit the water to enter or exit the hydraulic middle section chamber. The purpose is to start/stop the operating mode of this enablement on command. This is a feature found in conventional hydraulic circuits using a fossil-based fuel as the prime mover.

### Conclusion, Ramification and Scope

In summary this enablement has a prime mover (W2 & W3) and consumes no matter as it transforms energy from a renewable source. It is readily replicated and produced for volume energy needs. These are its principal advantages over other fossil-based systems in present use. This invention offers the World a relatively inexpensive method of producing energy without consuming any fuel or non-renewable resource in a completely environmentally friendly manner.

### ALTERNATE EMBODIMENTS

This invention has gone through several evolutionary stages of development, using somewhat different technology in the four prior Provisional Patent Applications previously submitted, which are, as follows:

| Pat. No. | | |
|---|---|---|
| 61/213,247 | 20 May 2009 | HYDROSTATIC ENGINE |
| 61/195,401 | 07 Oct. 2008 | HYDROSTATIC ENGINE |
| 61/129,468 | 30 Jun. 2008 | HYDROSTATIC ENGINE |
| 61/136,184 | 18 Aug. 2008 | HYDROSTATIC ENGINE |

It is our contention that the various technologies and designs contained in these prior PPA's could be combined in a number of useful ways, with minor modifications, using the technology of this Patent Application, for a number of valuable uses.

What is claimed is:

a. A revolutionary four cycle engine, which can be turned on or off on demand;

b. Which performs the four classic cycles (intake, force application, exhausting and expelling) simultaneously, with each stroke;

c. Which is a hydraulic system that has three independent chambers, each of which has a piston, all of which are connected by a single cylinder rod;

d. Which reciprocate as a single unit through their chambers and during the power stroke; two pistons drive the third piston, which works as a pump;

e. Then reversing by a reciprocating stroke to perform the same function in the opposite direction;

f. Submerged in a moving body of water oriented to capture the force of the moving stream;

g. Having raw water energy from both the flow and depth pressure of the water as the sole prime mover;

h. Capable of continuously operating in all respects within this environment and depth, as a complete hydraulic circuit;

i. As the sole prime mover for both the power and exhaust functions;

j. Which is achieved by transforming the raw energy from its environment by using hydraulic technology, Venturi-Eductor technology, a computer synchronized control system operating the various valves and other components to achieve a reciprocating power cycle;

k. This engine literally processes the water to capture energy; the water is then returned to the surrounding body of water;

l. The exhaust function, independent of the hydraulic side, is powered by the water, as the prime mover;

m. As a motive stream through the Venturi-Eductor assembly, the eductor being the linkage between the hydraulic cylinder and the Venturi tube;

n. And by the suction thereby created, clears the cylinder by creating a space or hole in front of the moving piston during the power stroke, in order to avoid the resistance from any back pressure;

o. The benefit of this process is making full use of the raw energy of water as it is changed in form to hydraulic and mechanical energy used to drive an electrical generator to produce electrical energy;

p. The energy output of this enablement is applied to an energy cell (accumulator) or directly to power a rotary hydraulic motor which drives an electrical generator;

q. All of these functions being within the state of art for electronic control of hydraulic functions and are performed in full compliance with Pascal's law and Bernoulli's Equations concerning the laws of conservation of energy;

r. Thereby, the result of the Hydro Actuated Engine is the most desirable form of energy creation in the world;

s. It makes use of an infinite renewable energy source and does not consume any matter in producing electrical energy.
